(19) United States
(12) Patent Application Publication
(10) Pub. No.: US 2026/0175120 A1
(43) Pub. Date: Jun. 25, 2026

(54) GAME ELEMENT DISPLAY METHOD AND APPARATUS, COMPUTER DEVICE, AND STORAGE MEDIUM

(71) Applicant: NETEASE (HANGZHOU) NETWORK CO., LTD., Hangzhou (CN)

(72) Inventor: Yunpeng LI, Hangzhou (CN)

(21) Appl. No.: 19/124,082

(22) PCT Filed: Aug. 3, 2023
(86) PCT No.: PCT/CN2023/111041

§ 371 Date: Apr. 24, 2025

(30) Foreign Application Priority Data
Oct. 24, 2022 (CN) 202211305613.7

(51) Int. Cl. A63F 13/00; A63F 13/537; G06F 3/04817

(52) U.S. Cl. CPC A63F 13/00; A63F 13/537; G06F 3/04817

(57) ABSTRACT

Disclosed are a game element display method and apparatus, a computer device, and a storage medium. The method comprises: in response determining that a first virtual character enters a battle state, replacing a battle association interface element in a thumbnail form displayed on a graphical user interface with a battle association interface element in an expanded form. The method further includes, in response to determining that the first virtual character is not in the battle state, restoring the battle association interface element in the expanded form displayed on the graphical user interface into the battle association interface element in the thumbnail form.

The present disclosure is a 371 national phase application of PCT Application No. PCT/CN2023/111041 filed Aug. 3, 2023, which claims priority to Chinese Patent Application No. 202211305613.7 filed with the Chinese Patent Office on Oct. 24, 2022, the entire contents of both of which applications are hereby incorporated by reference for all purposes.

### TECHNICAL FIELD

The present disclosure relates to the technical field of games, and specifically relates to a method for displaying a game element, an apparatus for displaying a game element, a computer device, and a storage medium.

### BACKGROUND

With the continuous development of computer communication technologies and the widespread popularization and application of terminals such as smart phones, tablet computers, and notebook computers, the terminals are developing towards diversification and personalization, and increasingly become indispensable terminals in people's life and work. In order to meet people's pursuit of spiritual life, entertainment games capable of being operated on the terminals have emerged. For example, games, such as Multiplayer Online Battle Arena (MOBA) and Massive Multiplayer Online (MMO), developed based on a client or a server architecture are characterized by, e.g., high fluency, good operation handfeel, and real-time battle, and are therefore deeply favored by users.

In current games, game interfaces will present different interface effects based on different game states of players, so that the players obtain corresponding information in different game states.

### SUMMARY

According to a first aspect, the present disclosure provides a method, comprising: providing a graphical user interface by a terminal, wherein the graphical user interface comprises a virtual scenario, a first virtual character located in the virtual scenario and controlled by the terminal, and a battle-related interface element, the battle-related interface element being configured to indicate battle-related battle information, the first virtual character being in an out-of-battle state, the battle-related interface element displayed on the graphical user interface being a battle-related interface element in a thumbnail form; in response to determining that the first virtual character enters a battle state, and replacing the battle-related interface element in the thumbnail form displayed on the graphical user interface with a battle-related interface element in an expanded form; and in response to determining that the first virtual character is out of the battle state, and restoring the battle-related interface element in the expanded form displayed on the graphical user interface to the battle-related interface element in the thumbnail form.

According to a second aspect, the present disclosure further provides a system, comprising one or more processors and one or more memories, the memory storing a plurality of computer-executable instructions. The one or more processors execute the instructions to perform the operations in the above method.

According to a third aspect, the present disclosure further provides non-transitory computer-readable storage medium, storing a plurality of instructions adapted to be loaded by one or more processors, to perform the operations in the above method.

### DESCRIPTION OF DRAWINGS

To more clearly describe technical solutions of embodiments of the present disclosure, drawings to be used in the description of the embodiments will be briefly introduced below. The drawings described below are merely some embodiments of the present disclosure. For those skilled in the art, other drawings may also be obtained based on these drawings without creative work.

FIG. 1 is a schematic scenario diagram of a system for displaying a game element provided in one of embodiments of the present disclosure.

FIG. 2 is a schematic flowchart of a method for displaying a game element provided in one of embodiments of the present disclosure.

FIG. 3 is a schematic diagram of an application scenario of a method for displaying a game element provided in one of embodiments of the present disclosure.

FIG. 4 is a schematic diagram of another application scenario of a method for displaying a game element provided in one of embodiments of the present disclosure.

FIG. 5a is a schematic diagram of another application scenario of a method for displaying a game element provided by one of embodiments of the present disclosure.

FIG. 5b is a schematic diagram of another application scenario of a method for displaying a game element provided in one of embodiments of the present disclosure.

FIG. 6 is a schematic diagram of another application scenario of a method for displaying a game element provided in one of embodiments of the present disclosure.

FIG. 7 is a schematic diagram of another application scenario of a method for displaying a game element provided in one of embodiments of the present disclosure.

FIG. 8 is a schematic diagram of another application scenario of a method for displaying a game element provided in one of embodiments of the present disclosure.

FIG. 9 is a schematic structural diagram of an apparatus for displaying a game element provided in one of embodiments of the present disclosure.

FIG. 10 is a schematic structural diagram of a computer device provided in one of embodiments of the present disclosure.

### EMBODIMENTS OF THE PRESENT DISCLOSURE

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

Embodiments of the present disclosure provide a method for displaying a game element, an apparatus for displaying a game element, a computer device, and a storage medium, which can, in some embodiments, solve problems such as that a game interface of the related art does not distinguish between a battle state and an out-of-battle state, thus resulting in prolonged display of battle interface information on the interface and cumbersome and messy interface display; and can, in some embodiments, solve problems such as that the game interface of the related art displays battle-related interface information in the battle state and hides the battle-related interface information in a non-battle state, but this will cause a player to fail in monitoring some special states, and affect strategic deployment of the player in a game, thereby affecting game experience of the player, and resulting in low game interaction efficiency.

The embodiments of the present disclosure provide a method for displaying a game element, an apparatus for displaying a game element, a computer device, and a storage medium, wherein, by responding to an event that the first virtual character enters a battle state, a battle-related interface element in the thumbnail form displayed on the graphical user interface is replaced with the battle-related interface element in an expanded form; and then, by responding to an event that the first virtual character is out of the battle state, the battle-related interface element in the expanded form displayed on the graphical user interface is restored to the battle-related interface element in the thumbnail form. In the embodiments of the present disclosure, battle-related interface elements corresponding to different game states are selectively displayed on the graphical user interface based on a game state of the first virtual character controlled by a player, which can provide different interface display information in a targeted manner, and display secondary battle information in a thumbnail manner to display it differently from important battle information, thereby improving game interaction efficiency of the player, enhancing the sense of immersion, improving the game experience of the player, reducing response frequency of the hardware device, and contributing to saving computing resources of the hardware device.

Technical solutions of embodiments of the present disclosure will be described clearly and completely below with reference to the drawings in the embodiments of the present disclosure. The described embodiments are merely some embodiments, instead of all embodiments, of the present disclosure. All other embodiments obtained by those skilled in the art based on the embodiments of the present disclosure without creative work are encompassed within the scope of protection of the present disclosure.

The embodiments of the present disclosure provide a method for displaying a game element, an apparatus for displaying a game element, a computer device, and a storage medium. Specifically, the method for displaying a game element in an embodiment of the present disclosure can be executed by a computer device, wherein the computer device may be a device, such as a terminal or a server. The terminal may be a terminal device, such as a smart phone, a tablet computer, a notebook computer, a touch screen, a game machine, a Personal Computer (PC), or a Personal Digital Assistant (PDA). The terminal may further comprise a client. The client may be, e.g., a game application client, a browser client carrying a game program, or an instant messaging client. The server may be a standalone physical server, or may be a server cluster or a distributed system composed of a plurality of physical servers, or may be a cloud server providing basic cloud computing service, such as cloud service, cloud database, cloud computing, cloud function, cloud storage, network service, cloud communication, middleware service, domain name service, security service, CDN, big data, and artificial intelligence platform.

For example, when the method for displaying a game element runs on the terminal, the terminal device may store a game application program, and may be used to present a virtual scenario in a game screen. The terminal device may be configured to interact with a user through a graphical user interface, such as downloading, installing, and running the game application program through the terminal device. The terminal device may provide the graphical user interface to the user in a variety of ways, for example, rendering and displaying on a display screen of the terminal device, or presenting the graphical user interface by holographic projection. For example, the terminal device may comprise a touch screen and a processor. The touch screen may be configured to present the graphical user interface and receive an operating instruction generated by the user acting on the graphical user interface. The graphical user interface comprises a game screen. The processor is configured to run the game, generate the graphical user interface, respond to the operating instruction, and control the display of the graphical user interface on the touch screen.

For example, when running on the server, the method for displaying a game element may be a cloud game. The cloud game may refer to a gaming method based on cloud computing. In an operating mode of the cloud game, an entity for running the game application program may be separated from an entity for presenting the game screen, and the storage and running of the method for displaying a game element may be completed on a cloud game server. The game screen presentation may be completed on a cloud game client. The cloud game client may be configured to receive and transmit game data and present the game screen. For example, the cloud game client may be a display device that is close to a user side and has a data transmission function, such as a mobile terminal, a television set, a computer, a handheld computer, or a personal digital assistant, but the terminal device that performs game data processing may be a cloud game server in cloud. When playing a game, the user may operate the cloud game client to transmit the operating instruction to the cloud game server. The cloud game server may run the game based on the operating instruction, encode and compress the data such as the game screen, and return the encoded and compressed data to the cloud game client through a network. Finally, the cloud game client may decode the encoded and compressed data, and output the game screen.

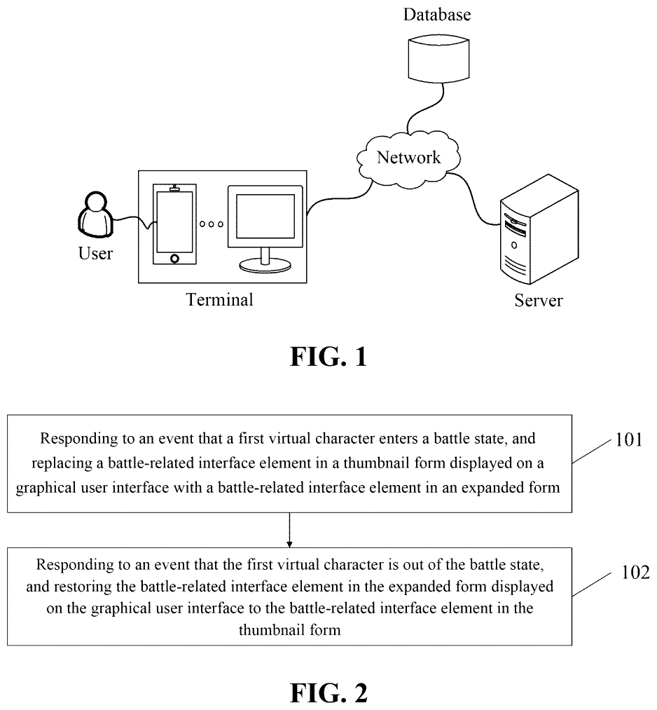

Referring to FIG. 1, FIG. 1 is a schematic scenario diagram of a system for displaying a game element provided in an embodiment of the present disclosure. The system may comprise at least one terminal, at least one server, at least one database, and a network. A terminal held by a user may be connected to servers of different games through the network. The terminal is any device with computing hardware capable of supporting and executing a software product corresponding to a game. In addition, when the system comprises a plurality of terminals, a plurality of servers, and a plurality of networks, different terminals may be connected to each other through different networks and different servers. The network may be a wireless network or a wired network. For example, the wireless network may be a wireless local area network (WLAN), a local area network (LAN), a cellular network, a 2G network, a 3G network, a 4G network, a 5G network, etc. In addition, different terminals may also be connected to other terminals or connected to servers using their own Bluetooth networks or hotspot networks. For example, a plurality of users may be online via different terminals, so that they are connected through appropriate networks and synchronized with each other, to support multi-player games. In addition, the system may comprise a plurality of databases coupled to different servers, and may continuously store information related to the game environment in the databases when different users are playing multi-player games online.

An embodiment of the present disclosure provides a method for displaying a game element. The method may be executed by a terminal or a server. The embodiment of the present disclosure is illustrated when the method for displaying a game element is executed by, for example, a terminal. The terminal may comprise a touch screen and a processor (in some embodiments, the terminal may also use a peripheral such as a mouse and a keyboard as an input device, and is illustrated here only with the touch screen as an example). The touch screen is configured to present a graphical user interface and receive an operating instruction generated by the user acting on the graphical user interface. When the user operates the graphical user interface through the touch screen, the graphical user interface not only can control local content of the terminal in response to the received operating instruction, but also can control content of a peer server in response to the received operating instruction. For example, the operating instruction generated by the user acting on the graphical user interface comprises an instruction for initiating a game application program, and the processor is configured to initiate the game application program after receiving the instruction for initiating the game application program provided by the user. In addition, the processor is configured to render and plot a graphical user interface associated with the game on the touch screen. The touch screen is a multi-touch sensitive screen that can sense touch or sliding operations simultaneously performed at a plurality of points on the screen. The user performs a touch operation on the graphical user interface using a finger. When detecting the touch operation, the graphical user interface controls different virtual objects in the graphical user interface of the game to perform actions corresponding to the touch operation. For example, the game may be any one of a casual game, an action game, a role-playing game, a strategy game, a sports game, a puzzle game, and the like. The game may comprise a virtual scenario of a game plotted on the graphical user interface. In addition, the virtual scenario of the game may comprise one or more virtual objects, such as a virtual character, controlled by the user (or player). In addition, the virtual scenario of the game may further comprise one or more obstacles, such as railings, ravines, and walls, to restrict movement of the virtual object, such as restricting movement of one or more objects to a particular region within the virtual scenario. In some embodiments, the virtual scenario of the game further comprises one or more elements, such as skills, scores, character health status, or energy, to provide the player with help and virtual services, and increase scores related to the player performance, etc. In addition, the graphical user interface may further present one or more indicators to provide the player with indication information. For example, the game may comprise a player-controlled virtual object and one or more other virtual objects (such as enemy characters). In an embodiment, the one or more other virtual objects are controlled by other players of the game. For example, the one or more other virtual objects may be controlled by a computer, such as a robot using an artificial intelligence (AI) algorithm, to implement a man-machine battle mode. For example, the virtual object owns various skills or abilities used by a game player to achieve his goals. For example, the virtual object owns one or more weapons, props, tools, etc. that can be used to eliminate other objects from the game. Such skills or abilities may be activated by the game player using one of a plurality of preset touch operations on the touch screen of the terminal. The processor may be configured to present a corresponding game screen in response to the operating instruction generated by the touch operation of the user.

It should be noted that the schematic scenario diagram of the system for displaying a game element shown in FIG. 1 is merely an example. The system for displaying a game element and the scenario are described in the embodiments of the present disclosure to more clearly illustrate the technical solutions of the embodiments of the present disclosure, and do not impose any limitation on the technical solutions provided in the embodiments of the present disclosure. As appreciated by those of ordinary skills in the art, with the emergence of new service scenarios, the technical solutions provided in the embodiments of the present disclosure may also be adapted to similar technical problems.

Based on the above and other problems, the embodiments of the present disclosure provide a method for displaying a game element, an apparatus for displaying a game element, a computer device, and a storage medium, which can improve the game interaction efficiency of the player in the game. The detailed description will be provided below respectively. It should be noted that the order of description of the embodiments below does not impose any limitation on a preferred order of the embodiments.

An embodiment of the present disclosure provides a method for displaying a game element. The method may be executed by a terminal or a server. The embodiment of the present disclosure is illustrated when the method for displaying a game element is executed by, for example, a terminal. In an embodiment of the present disclosure, a graphical user interface is provided by a terminal, wherein the graphical user interface comprises at least a part of a virtual scenario, a first virtual character located in the virtual scenario and controlled by the terminal device, and at least one battle-related interface element. The battle-related interface element is configured to indicate battle-related battle information, the first virtual character is in an out-of-battle state, and the battle-related interface element displayed on the graphical user interface is a battle-related interface element in a thumbnail form. The battle-related battle information with which the battle-related interface element is configured may be skill information of a game skill of the first virtual character, or may be a teammate of the first virtual character, that is, character information of a second virtual character, or may be other battle-related battle information.

In an embodiment of the present disclosure, a game screen is displayed on the graphical user interface, the game screen comprises a virtual scenario, and the virtual scenario is a virtual environment displayed (or provided) when the application program is running on the terminal. The virtual environment may be a simulation environment of the real world, or may be a partially simulated and partially fictional three-dimensional environment, or may be a purely fictional three-dimensional environment. The virtual environment is used for a virtual environment battle between at least two virtual characters, and virtual resources in the virtual environment are available for at least two virtual characters. The virtual scenario is displayed on the game interface, and one or more virtual characters may be displayed in the virtual scenario. The virtual characters may comprise a first virtual character, a second virtual character, and a third virtual character, wherein the second virtual character is a virtual character in a same camp as the first virtual character, and the third virtual character is a virtual character in a different camp from the first virtual character. The first virtual character, the second virtual character, and the third virtual character may exist simultaneously in the virtual scenario, which is merely example description here, and does not impose any limitation. A virtual character (or hero) refers to a movable object in a virtual environment. A virtual character refers to a virtual object controlled by a user or a player through a terminal in a game. In an embodiment of the present disclosure, the first virtual object refers to a virtual object controlled by a current player through the terminal in the game, that is, a virtual character controlled by a player using a local terminal. The second virtual character and the third virtual character refer to virtual objects controlled by other users through the terminal in the game, that is, virtual characters controlled by users using other terminals.

Referring to FIG. 2, FIG. 2 is a schematic flowchart of a method for displaying a game element provided in an embodiment of the present disclosure. Specific processes of the method for displaying a game element may be steps 101 to 102 as below:

101: responding to an event that a first virtual character enters a battle state, and replacing a battle-related interface element in a thumbnail form displayed on a graphical user interface with a battle-related interface element in an expanded form.

In order to determine a current state of the first virtual character, before the step “responding to the event that the first virtual character enters the battle state”, the method further comprises:
determining whether a current location of the first virtual character belongs to a preset battle region; and
determining, in response to the first virtual character currently being located in the preset battle region, that the first virtual character enters the battle state, and responding to the event that the first virtual character enters the battle state.

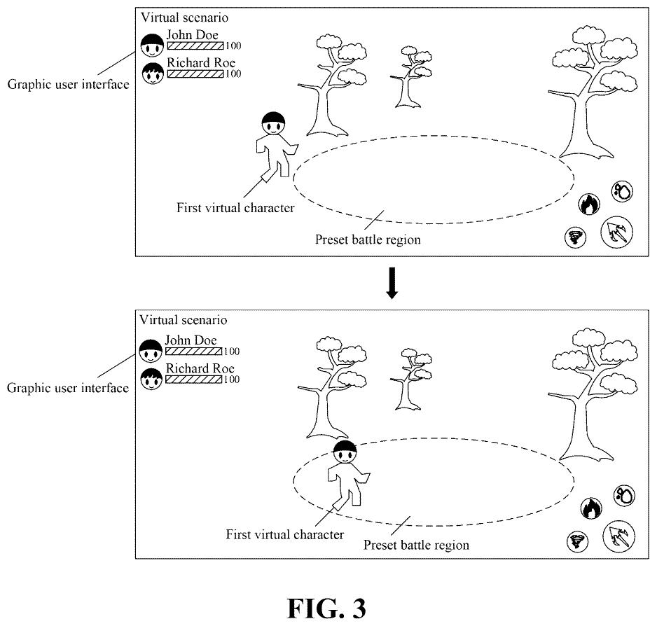

For example, referring to FIG. 3, the first virtual character controlled by the user may be located in the virtual scenario. In this case, the first virtual character does not walk into the preset battle region, so that the first virtual character does not enter the battle state. When the user controls the first virtual character to move in the virtual scenario, a computer device determines whether the current location of the first virtual character belongs to the preset battle region, determines, if the first virtual character is currently located in the preset battle region, that the first virtual character enters the battle state, and responds to the event that the first virtual character enters the battle state.

In some embodiments, before the step of “responding to the event that the first virtual character enters the battle state”, the method further comprises:
determining whether the first virtual character and other virtual characters have a game event of attacking or being attacked; and
determining, in response to the first virtual character and the other virtual characters have a game event of attacking or being attacked, that the first virtual character is in battle, and responding to the event that the first virtual character enters the battle state.

Specifically, when the first virtual object is damaged by attacks from the other virtual characters in the virtual scenario, or when the first virtual character attacks the other virtual characters in the virtual scenario, the first virtual character is determined to be in battle, and the event that the first virtual character enters the battle state is responded to.

Further, the graphical user interface further comprises a second virtual character in a same camp as the first virtual character in the virtual scenario. Before the step of “responding to the event that the first virtual character enters the battle state”, the method further comprises:
determining, in response to detecting that the second virtual character enters the battle state, that the first virtual character is in battle, and responding to the event that the first virtual character enters the battle state.

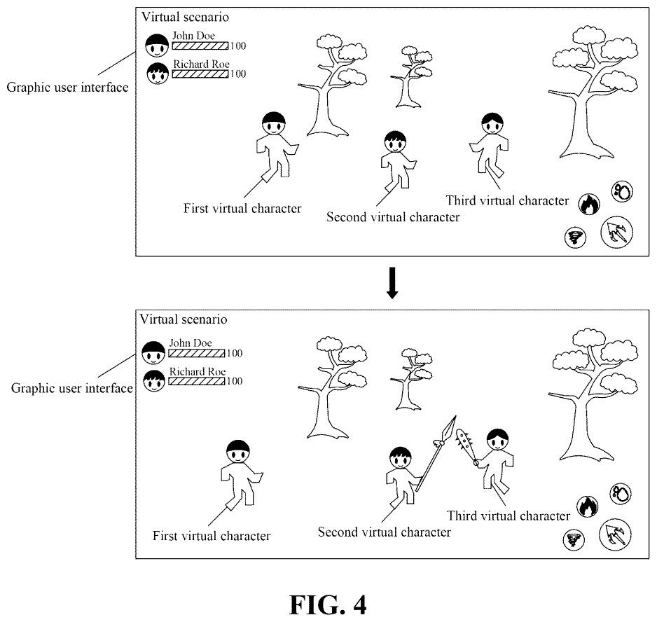

For example, referring to FIG. 4, the first virtual character controlled by the user may be located in the virtual scenario, and when detecting that the second virtual character and the third virtual character are in battle, the computer device determines that the second virtual character enters the battle state, thereby determining that the first virtual character is in battle, and responds to the event that the first virtual character enters the battle state.

102: responding to an event that the first virtual character is out of the battle state, and restoring the battle-related interface element in the expanded form displayed on the graphical user interface to the battle-related interface element in the thumbnail form.

In an embodiment of the present disclosure, the battle-related interface element in the expanded form comprises a plurality of element display identifiers. The step “responding to the event that the first virtual character is out of the battle state, and restoring the battle-related interface element in the expanded form displayed on the graphical user interface to the battle-related interface element in the thumbnail form” comprises:
responding to the event that the first virtual character is out of the battle state, determining a target element display identifier from the plurality of element display identifiers, generating a thumbnail element identifier based on the target element display identifier and current battle information associated with the target element display identifier, and using the thumbnail element identifier as the battle-related interface element in the thumbnail form; and
replacing the battle-related interface element in the expanded form displayed on the graphical user interface with the thumbnail element identifier, and canceling display of other element display identifiers among the plurality of element display identifiers on the graphical user interface.

In a specific embodiment, the plurality of element display identifiers comprise a shortcut key identifier, an element graphic identifier, and a text identifier, wherein the shortcut key identifier is used for notifying a player to control the first virtual character to trigger the battle-related interface element associated with the shortcut key identifier in the virtual scenario. The step “responding to the event that the first virtual character is out of the battle state, determining the target element display identifier from the plurality of element display identifiers, generating the thumbnail element identifier based on the target element display identifier and the current battle information associated with the target element display identifier, and using the thumbnail element identifier as the battle-related interface element in the thumbnail form” may comprise:
responding to the event that the first virtual character is out of the battle state, determining the shortcut key identifier from the plurality of element display identifiers as the target element display identifier, generating a thumbnail shortcut identifier based on the shortcut key identifier and the current battle information associated with the battle-related interface element, and using the thumbnail shortcut identifier as the battle-related interface element in the thumbnail form; and
the replacing the battle-related interface element in the expanded form displayed on the graphical user interface with the thumbnail element identifier, and canceling the display of the other element display identifiers among the plurality of element display identifiers on the graphical user interface comprises:
replacing the battle-related interface element in the expanded form displayed on the graphical user interface with the thumbnail shortcut identifier, and canceling display of the element graphic identifier and the text identifier on the graphical user interface.

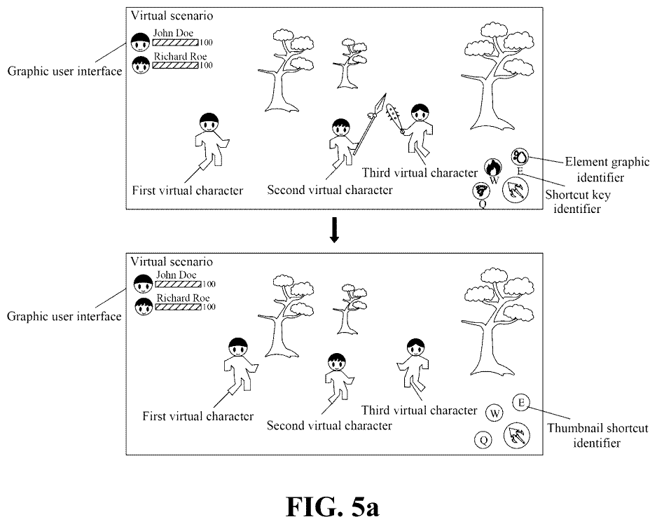

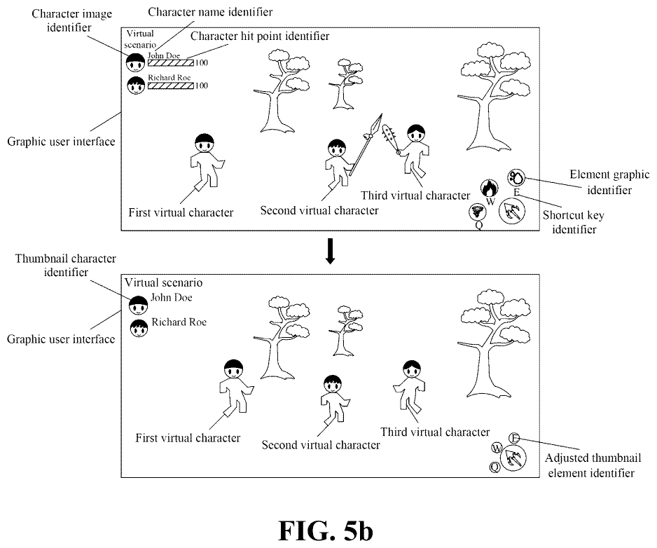

For example, referring to FIG. 5a, the plurality of element display identifiers may comprise the shortcut key identifier and the element graphic identifier. After detecting that the second virtual character and the third virtual character finish the battle, the computer device determines that the first virtual character follows the second virtual character to be out of the battle, responds to the event that the first virtual character is out of the battle state, determines the shortcut key identifier from the plurality of element display identifiers as the target element display identifier, generates a thumbnail shortcut identifier based on the shortcut key identifier and the current battle information associated with the battle-related interface element, and uses the thumbnail shortcut identifier as the battle-related interface element in the thumbnail form. Then, the battle-related interface element (the shortcut key identifier and the element graphic identifier) in the expanded form displayed on the graphical user interface is replaced with the thumbnail shortcut identifier, and the display of the element graphic identifier and the text identifier on the graphical user interface is canceled.

For example, referring to FIG. 5b, the plurality of element display identifiers may comprise character information, a shortcut key identifier, and an element graphic identifier of a friendly camp. After detecting that the second virtual character and the third virtual character finish the battle, the computer device determines that the first virtual character follows the second virtual character to be out of the battle, responds to the event that the first virtual character is out of the battle state, determines the character information and the shortcut key identifier of the friendly camp from the plurality of element display identifiers as target element display identifiers, generates a thumbnail shortcut identifier based on the shortcut key identifier and the current battle information associated with the battle-related interface element, wherein in this case, the character information of the friendly camp comprises character information of a first virtual character and character information of a second virtual character, and may comprise a character image identifier, a character name identifier (such as John Doe and Richard Roe) and a character hit point identifier (such as a hit point bar and a hit point value), generates a thumbnail character identifier based on the character information of the friendly camp, and uses the thumbnail character identifier and the thumbnail shortcut identifier as battle-related interface elements in the thumbnail form. Then, the battle-related interface elements (the character information, the shortcut key identifier, and the element graphic identifier of the friendly camp) in the expanded form displayed on the graphical user interface are replaced with the thumbnail shortcut identifier and the thumbnail character identifier, and display of the character hit point identifier, the element graphic identifier, and the text identifier on the graphical user interface is canceled.

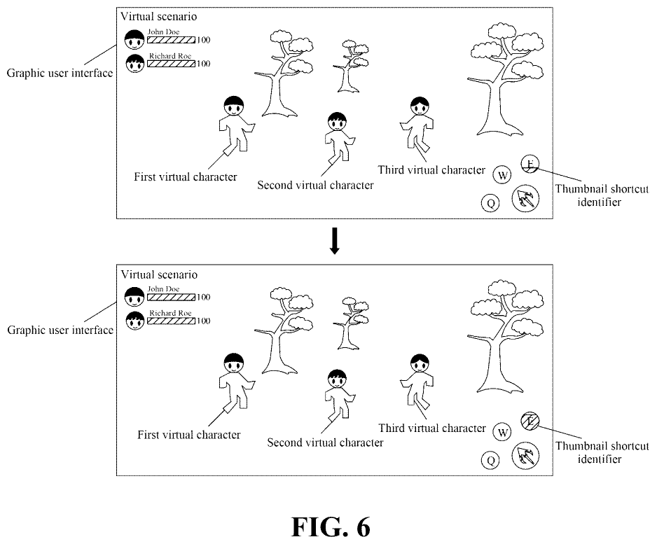

In some embodiments, the battle-related interface element may be associated with a game skill, and a shadow display ratio in the thumbnail shortcut identifier may be updated based on cool down time of the game skill. As shown in FIG. 6, cool down time of a game skill corresponding to the thumbnail shortcut identifier is 5 seconds, the computer device can detect that cooled down time of the game skill corresponding to the thumbnail shortcut identifier is 1 second, and then the shadow display ratio in the thumbnail shortcut identifier is 20%. When the cooled down time of the game skill corresponding to the thumbnail shortcut identifier is detected to be 4 seconds, the shadow display ratio in the thumbnail shortcut identifier is updated from 20% to 80%, thereby reminding the player that cool down of the game skill is about to be completed.

In order to display different skill types differently when the first virtual character is out of the battle state, to notify the player of the skills in the thumbnail state differently, when the computer device detects that the first virtual character is out of the battle, the computer device responds to the event that the first virtual character is out of the battle state, determines the shortcut key identifier from the plurality of element display identifiers as the target element display identifier, ascertains a skill type of a game skill corresponding to the shortcut key identifier, determines a conventional game skill and a special game skill respectively, generates a first shortcut key identifier and a second shortcut key identifier respectively based on a first specified color corresponding to the conventional game skill and a second specified color of the special game skill, and uses the first shortcut key identifier and the second shortcut key identifier as the battle-related interface elements in the thumbnail form. Then, the battle-related interface elements (the shortcut key identifier and the element graphic identifier) in the expanded form displayed on the graphical user interface are replaced with the thumbnail shortcut identifiers, and the display of the element graphic identifier and the text identifier on the graphical user interface is canceled. For example, the first shortcut key identifier of the conventional game skill is grayscaled, and the second shortcut key identifier of the special game skill is highlighted. For another example, the first shortcut key identifier of the conventional game skill is displayed in a first color, the second shortcut key identifier of the special game skill is displayed in a second color, and the first color is different from the second color.

For example, the step “responding to the event that the first virtual character is out of the battle state, determining the target element display identifier from the plurality of element display identifiers, generating the thumbnail element identifier based on the target element display identifier and the current battle information associated with the target element display identifier, and using the thumbnail element identifier as the battle-related interface element in the thumbnail form” may comprise:
responding to the event that the first virtual character is out of the battle state, determining the element graphic identifier from the plurality of element display identifiers as the target element display identifier, generating a thumbnail element graphic identifier based on the element graphic identifier and the current battle information associated with the battle-related interface element, and using the thumbnail element graphic identifier as the battle-related interface element in the thumbnail form; and
the replacing the battle-related interface element in the expanded form displayed on the graphical user interface with the thumbnail element graphic identifier, and canceling the display of the other element display identifiers among the plurality of element display identifiers on the graphical user interface comprises:
replacing the battle-related interface element in the expanded form displayed on the graphical user interface with the thumbnail shortcut identifier, and canceling display of the shortcut key identifier and the text identifier on the graphical user interface.

In some embodiments, the step “responding to the event that the first virtual character is out of the battle state, determining the target element display identifier from the plurality of element display identifiers, generating the thumbnail element identifier based on the target element display identifier and the current battle information associated with the target element display identifier, and using the thumbnail element identifier as the battle-related interface element in the thumbnail form” may comprise:
responding to the event that the first virtual character is out of the battle state, determining the text identifier from the plurality of element display identifiers as the target element display identifier, generating a thumbnail text identifier based on the text identifier and the current battle information associated with the battle-related interface element, and using the thumbnail text identifier as the battle-related interface element in the thumbnail form; and
the replacing the battle-related interface element in the expanded form displayed on the graphical user interface with the thumbnail text identifier, and canceling the display of the other element display identifiers among the plurality of element display identifiers on the graphical user interface comprises:
replacing the battle-related interface element in the expanded form displayed on the graphical user interface with the thumbnail shortcut identifier, and canceling display of the shortcut key identifier and the element graphic identifier on the graphical user interface.

In order to display the thumbnail element identifier and the element display identifier differently, after the step “generating the thumbnail element identifier based on the target element display identifier and the current battle information associated with the target element display identifier”, and before the “using the thumbnail element identifier as the battle-related interface element in the thumbnail form”, the method further comprises:
adjusting, in response to a size adjustment instruction for the thumbnail element identifier, a display size of the thumbnail element identifier to obtain an adjusted thumbnail element identifier, wherein a display size of the adjusted thumbnail element identifier is smaller than a display size of the element display identifier; and
using the adjusted thumbnail element identifier as the battle-related interface element in the thumbnail form.

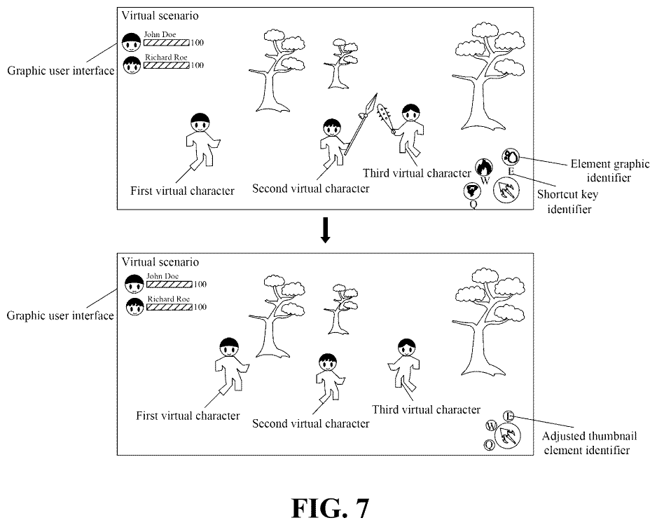

For example, referring to FIG. 7, the plurality of element display identifiers may comprise the shortcut key identifier and the element graphic identifier. After detecting that the second virtual character and the third virtual character finish the battle, the computer device determines that the first virtual character follows the second virtual character to be out of the battle, responds to the event that the first virtual character is out of the battle state, determines the shortcut key identifier from the plurality of element display identifiers as the target element display identifier, generates a thumbnail shortcut identifier based on the shortcut key identifier and the current battle information associated with the battle-related interface element, and uses the thumbnail shortcut identifier as the battle-related interface element in the thumbnail form. The computer device adjusts, in response to a size adjustment instruction for the thumbnail element identifier, a display size of the thumbnail element identifier to obtain an adjusted thumbnail element identifier, wherein a display size of the adjusted thumbnail element identifier is smaller than a display size of the element display identifier, then replaces the battle-related interface elements (the shortcut key identifier and the element graphic identifier) in the expanded form displayed on the graphical user interface with the adjusted thumbnail element identifier, and cancels the display of the element graphic identifier and the text identifier on the graphical user interface.

In some embodiments, after the step “generating the thumbnail element identifier based on the target element display identifier and the current battle information associated with the target element display identifier”, and before the “using the thumbnail element identifier as the battle-related interface element in the thumbnail form”, the method further comprises:
setting, in response to a color adjustment instruction for the thumbnail element identifier, a display color of the thumbnail element identifier to a specified display color to obtain a set thumbnail element identifier, wherein the display color of the set thumbnail element identifier is different from a display color of the element display identifier, so that the set thumbnail element identifier and the element display identifier are displayed differently; and
using the set thumbnail element identifier as the battle-related interface element in the thumbnail form.

In order to enable the user to view battle information in a personalized way, after the step “replacing the battle-related interface element in the expanded form displayed on the graphical user interface with the thumbnail element identifier, and canceling the display of the other element display identifiers among the plurality of element display identifiers on the graphical user interface”, the method further comprises:
restoring, in response to a first touch operation for the graphical user interface and during a duration of the first touch operation, the display of the other element display identifiers among the plurality of element display identifiers on the graphical user interface; and
canceling, in response to detecting that the first touch operation is ended, the display of the other element display identifiers among the plurality of element display identifiers on the graphical user interface.

In order to enable the user to selectively view battle information corresponding to the battle-related interface element, after the step “replacing the battle-related interface element in the expanded form displayed on the graphical user interface with the thumbnail element identifier, and canceling the display of the other element display identifiers among the plurality of element display identifiers on the graphical user interface”, the method further comprises:
displaying, in response to a second touch operation for the thumbnail element identifier, an information display window on the graphical user interface, wherein the information display window is used to display all current battle information associated with the thumbnail element identifier; and
canceling, in response to any position on the graphical user interface other than the information display window, the display of the information display window.

In an embodiment, in order to enable the user to adjust interface information displayed on the graphical user interface in a personalized way, after the step “replacing the battle-related interface element in the expanded form displayed on the graphical user interface with the thumbnail element identifier, and canceling the display of the other element display identifiers among the plurality of element display identifiers on the graphical user interface”, the method further comprises:
canceling, in response to a third touch operation for the thumbnail element identifier, display of the thumbnail element identifier on the graphical user interface.

In a specific embodiment, after the step “replacing the battle-related interface element in the expanded form displayed on the graphical user interface with the thumbnail element identifier, and canceling the display of the other element display identifiers among the plurality of element display identifiers on the graphical user interface”, the method further comprises:
canceling, in response to a touch operation for the graphical user interface, display of all thumbnail element identifiers on the graphical user interface on the graphical user interface.

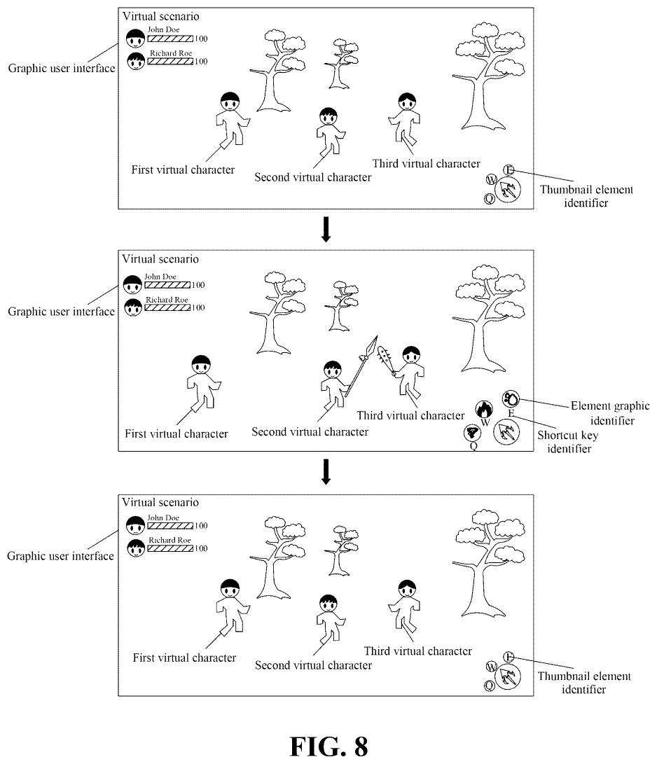

Based on the above introduction, an example will be given below to further illustrate the method for displaying a game element of the present disclosure. For example, referring to FIG. 8, a specific embodiment of the method for displaying a game element is as follows:

(1) a graphical user interface is displayed on a touch screen of a computer device, wherein the graphical user interface comprises at least a part of a virtual scenario, a first virtual character, a second virtual character and a third virtual character located in the virtual scenario and controlled by the terminal device, and at least one battle-related interface element. The battle-related interface element is configured to indicate battle-related battle information, the first virtual character is in an out-of-battle state, and the battle-related interface element displayed on the graphical user interface is a battle-related interface element in a thumbnail form, i.e., a thumbnail shortcut identifier is displayed.

(2) The first virtual character controlled by a user may be located in the virtual scenario, and when detecting that the second virtual character and the third virtual character are in battle, the computer device determines that the second virtual character enters a battle state, thereby determining that the first virtual character is in battle, responds to the event that the first virtual character enters the battle state, and replaces the battle-related interface element in the thumbnail form displayed on the graphical user interface with the battle-related interface element in an expanded form, wherein the battle-related interface element in the expanded form comprises a plurality of element display identifiers, and the plurality of element display identifiers may comprise a shortcut key identifier and an element graphic identifier.

(3) After detecting that the second virtual character and the third virtual character finish the battle, the computer device determines that the first virtual character follows the second virtual character to be out of the battle, responds to the event that the first virtual character is out of the battle state, determines the shortcut key identifier from the plurality of element display identifiers as the target element display identifier, generates a thumbnail shortcut identifier based on the shortcut key identifier and the current battle information associated with the battle-related interface element, and uses the thumbnail shortcut identifier as the battle-related interface element in the thumbnail form. Then, the battle-related interface element (the shortcut key identifier and the element graphic identifier) in the expanded form displayed on the graphical user interface is replaced with the thumbnail shortcut identifier, and the display of the element graphic identifier and the text identifier on the graphical user interface is canceled.

In summary, the embodiments of the present disclosure provide a method for displaying a game element, wherein, by responding to an event that the first virtual character enters a battle state, a battle-related interface element in the thumbnail form displayed on the graphical user interface is replaced with the battle-related interface element in an expanded form; and then, by responding to an event that the first virtual character is out of the battle state, the battle-related interface element in the expanded form displayed on the graphical user interface is restored to the battle-related interface element in the thumbnail form. In the embodiments of the present disclosure, battle-related interface elements corresponding to different game states are selectively displayed on the graphical user interface based on a game state of the first virtual character controlled by a player, which can provide different interface display information in a targeted manner, and display secondary battle information in a thumbnail manner to display it differently from important battle information, thereby improving game interaction efficiency of the player, enhancing the sense of immersion, and improving the game experience of the player.

In order to facilitate better implementation of the method for displaying a game element provided in the embodiments of the present disclosure, an embodiment of the present disclosure further provides an apparatus for displaying a game element based on the above method for displaying a game element. Meanings of the terms are same as those in the above method for displaying a game element. The description in the method embodiments may be referred to for specific implementation details.

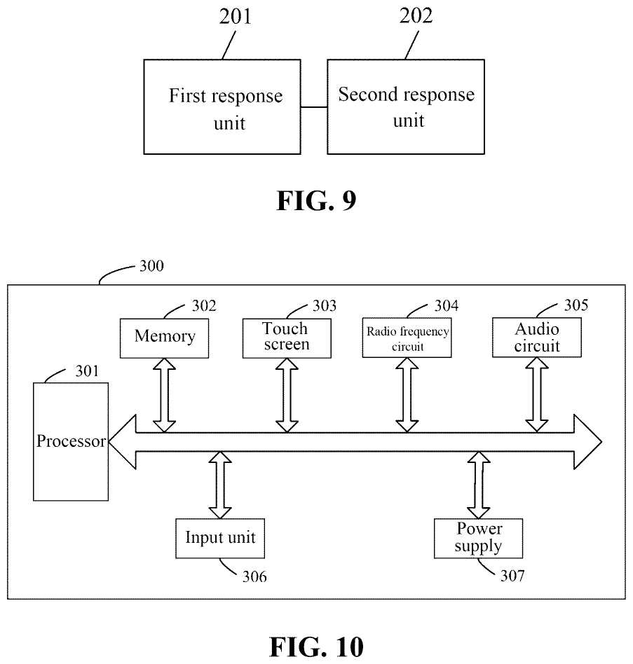

Referring to FIG. 9, FIG. 9 is a schematic structural diagram of an apparatus for displaying a game element provided in an embodiment of the present disclosure. The apparatus comprises:
a first response unit 201 configured to respond to an event that a first virtual character enters a battle state, and replace a battle-related interface element in a thumbnail form displayed on a graphical user interface with the battle-related interface element in an expanded form; and
a second response unit 202 configured to respond to an event that the first virtual character is out of the battle state, and restore the battle-related interface element in the expanded form displayed on the graphical user interface to the battle-related interface element in the thumbnail form.

In some embodiments, the apparatus for displaying a game element comprises:
a first response subunit configured to respond to the event that the first virtual character is out of the battle state, determine a target element display identifier from the plurality of element display identifiers, generate a thumbnail element identifier based on the target element display identifier and current battle information associated with the target element display identifier, and use the thumbnail element identifier as the battle-related interface element in the thumbnail form; and
a first replacement subunit configured to replace the battle-related interface element in the expanded form displayed on the graphical user interface with the thumbnail element identifier, and cancel display of other element display identifiers among the plurality of element display identifiers on the graphical user interface.

In some embodiments, the apparatus for displaying a game element comprises:
a second response subunit configured to respond to the event that the first virtual character is out of the battle state, determine the shortcut key identifier from the plurality of element display identifiers as the target element display identifier, generate a thumbnail shortcut identifier based on the shortcut key identifier and the current battle information associated with the battle-related interface element, and use the thumbnail shortcut identifier as the battle-related interface element in the thumbnail form.

In some embodiments, the apparatus for displaying a game element comprises:
a second replacement subunit configured to replace the battle-related interface element in the expanded form displayed on the graphical user interface with the thumbnail shortcut identifier, and cancel display of the element graphic identifier and the text identifier on the graphical user interface.

In some embodiments, the apparatus for displaying a game element comprises:
a first adjustment subunit configured to adjust, in response to a size adjustment instruction for the thumbnail element identifier, a display size of the thumbnail element identifier to obtain an adjusted thumbnail element identifier, wherein a display size of the adjusted thumbnail element identifier is smaller than a display size of the element display identifier;
the first adjustment subunit being further configured to use the adjusted thumbnail element identifier as the battle-related interface element in the thumbnail form.

In some embodiments, the apparatus for displaying a game element comprises:
a third response subunit configured to set, in response to a color adjustment instruction for the thumbnail element identifier, a display color of the thumbnail element identifier to a specified display color to obtain a set thumbnail element identifier, wherein the display color of the set thumbnail element identifier is different from a display color of the element display identifier, so that the set thumbnail element identifier and the element display identifier are displayed differently;
the third response subunit being further configured to use the set thumbnail element identifier as the battle-related interface element in the thumbnail form.

In some embodiments, the apparatus for displaying a game element comprises:
a fourth response subunit configured to restore, in response to a first touch operation for the graphical user interface and during a duration of the first touch operation, the display of the other element display identifiers among the plurality of element display identifiers on the graphical user interface; and
a processing subunit configured to cancel, in response to detecting that the first touch operation is ended, the display of the other element display identifiers among the plurality of element display identifiers on the graphical user interface.

In some embodiments, the apparatus for displaying a game element comprises:
a fifth response subunit configured to display, in response to a second touch operation for the thumbnail element identifier, an information display window on the graphical user interface, wherein the information display window is used to display all current battle information associated with the thumbnail element identifier;
the fifth response subunit being further configured to cancel, in response to any position on the graphical user interface other than the information display window, the display of the information display window.

In some embodiments, the apparatus for displaying a game element comprises:
a sixth response subunit configured to cancel, in response to a third touch operation for the thumbnail element identifier, display of the thumbnail element identifier on the graphical user interface.

In some embodiments, the apparatus for displaying a game element comprises:
a seventh response subunit configured to cancel, in response to a touch operation for the graphical user interface, display of all thumbnail element identifiers on the graphical user interface on the graphical user interface.

In some embodiments, the apparatus for displaying a game element comprises:
a first determination subunit configured to determine whether a current location of the first virtual character belongs to a preset battle region;
the first determination subunit being further configured to determine, in response to the first virtual character currently being located in the preset battle region, that the first virtual character enters the battle state, and respond to the event that the first virtual character enters the battle state.

In some embodiments, the apparatus for displaying a game element comprises:
a second determination subunit configured to determine whether the first virtual character and other virtual characters have a game event of attacking or being attacked;
the second determination subunit being further configured to determine, in response to the first virtual character and the other virtual characters have a game event of attacking or being attacked, that the first virtual character is in battle, and respond to the event that the first virtual character enters the battle state.

In some embodiments, the apparatus for displaying a game element comprises:
a third determination subunit configured to determine, in response to detecting that the second virtual character enters the battle state, that the first virtual character is in battle, and respond to the event that the first virtual character enters the battle state.

The embodiments of the present disclosure provide an apparatus for displaying a game element, wherein, by responding to an event that the first virtual character enters a battle state, the first response unit 201 replaces a battle-related interface element in the thumbnail form displayed on the graphical user interface with the battle-related interface element in an expanded form; and then the second response unit 202 responds to an event that the first virtual character is out of the battle state, and restores the battle-related interface element in the expanded form displayed on the graphical user interface to the battle-related interface element in the thumbnail form. In the embodiments of the present disclosure, battle-related interface elements corresponding to different game states are selectively displayed on the graphical user interface based on a game state of the first virtual character controlled by a player, which can provide different interface display information in a targeted manner, and display secondary battle information in a thumbnail manner to display it differently from important battle information, thereby improving game interaction efficiency of the player, enhancing the sense of immersion, and improving the game experience of the player.

Accordingly, an embodiment of the present disclosure further provides a computer device. The computer device may be a terminal or a server. The terminal may be a terminal device, such as a smart phone, a tablet computer, a notebook computer, a touch screen, a game machine, a Personal Computer (PC), or a Personal Digital Assistant (PDA). As shown in FIG. 10, FIG. 10 is a schematic structural diagram of a computer device provided in an embodiment of the present disclosure. The computer device 300 comprises a processor 301 having one or more than one processing core, a memory 302 having one or more than one computer-readable storage medium, and a computer program stored on the memory 302 and runnable on the processor. The processor 301 is electrically connected to the memory 302. Those skilled in the art can understand that the structure of the computer device shown in the figure does not constitute any limitation to the computer device, and may comprise more or fewer components than those shown in the figure, or may combine some components, or may have different component arrangements.

The processor 301 is a control center of the computer device 300, connects various parts of the entire computer device 300 using various interfaces and wires, implements various functions of the computer device 300 by running or loading software programs and/or modules stored in the memory 302, and implements data processing by invoking data stored in the memory 302, thereby performing overall monitoring on the computer device 300.

In an embodiment of the present disclosure, the processor 301 in the computer device 300 will load instructions corresponding to processes of one or more than one application program into the memory 302 following the steps below, and the processor 301 runs the application program stored in the memory 302, thereby implementing various functions:
responding to an event that the first virtual character enters a battle state, and replacing the battle-related interface element in the thumbnail form displayed on the graphical user interface with a battle-related interface element in an expanded form; and
responding to an event that the first virtual character is out of the battle state, and restoring the battle-related interface element in the expanded form displayed on the graphical user interface to the battle-related interface element in the thumbnail form.

In an embodiment, the battle-related interface element in the expanded form comprises a plurality of element display identifiers; and
the responding to the event that the first virtual character is out of the battle state, and restoring the battle-related interface element in the expanded form displayed on the graphical user interface to the battle-related interface element in the thumbnail form comprises:
responding to the event that the first virtual character is out of the battle state, determining a target element display identifier from the plurality of element display identifiers, generating a thumbnail element identifier based on the target element display identifier and current battle information associated with the target element display identifier, and using the thumbnail element identifier as the battle-related interface element in the thumbnail form; and
replacing the battle-related interface element in the expanded form displayed on the graphical user interface with the thumbnail element identifier, and canceling display of other element display identifiers among the plurality of element display identifiers on the graphical user interface.

In an embodiment, the plurality of element display identifiers comprise a shortcut key identifier, an element graphic identifier, and a text identifier, wherein the shortcut key identifier is used for notifying a player to control the first virtual character to trigger the battle-related interface element associated with the shortcut key identifier in the virtual scenario;
the responding to the event that the first virtual character is out of the battle state, determining the target element display identifier from the plurality of element display identifiers, generating the thumbnail element identifier based on the target element display identifier and the current battle information associated with the target element display identifier, and using the thumbnail element identifier as the battle-related interface element in the thumbnail form comprises:
responding to the event that the first virtual character is out of the battle state, determining the shortcut key identifier from the plurality of element display identifiers as the target element display identifier, generating a thumbnail shortcut identifier based on the shortcut key identifier and the current battle information associated with the battle-related interface element, and using the thumbnail shortcut identifier as the battle-related interface element in the thumbnail form; and
the replacing the battle-related interface element in the expanded form displayed on the graphical user interface with the thumbnail element identifier, and canceling the display of the other element display identifiers among the plurality of element display identifiers on the graphical user interface comprises:
replacing the battle-related interface element in the expanded form displayed on the graphical user interface with the thumbnail shortcut identifier, and canceling display of the element graphic identifier and the text identifier on the graphical user interface.

In an embodiment, after the generating the thumbnail element identifier based on the target element display identifier and the current battle information associated with the target element display identifier, and before the using the thumbnail element identifier as the battle-related interface element in the thumbnail form, the implementation further comprises:
adjusting, in response to a size adjustment instruction for the thumbnail element identifier, a display size of the thumbnail element identifier to obtain an adjusted thumbnail element identifier, wherein a display size of the adjusted thumbnail element identifier is smaller than a display size of the element display identifier; and
using the adjusted thumbnail element identifier as the battle-related interface element in the thumbnail form.

In an embodiment, after the generating the thumbnail element identifier based on the target element display identifier and the current battle information associated with the target element display identifier, and before the using the thumbnail element identifier as the battle-related interface element in the thumbnail form, the implementation further comprises:
setting, in response to a color adjustment instruction for the thumbnail element identifier, a display color of the thumbnail element identifier to a specified display color to obtain a set thumbnail element identifier, wherein the display color of the set thumbnail element identifier is different from a display color of the element display identifier, so that the set thumbnail element identifier and the element display identifier are displayed differently; and
using the set thumbnail element identifier as the battle-related interface element in the thumbnail form.

In an embodiment, after the replacing the battle-related interface element in the expanded form displayed on the graphical user interface with the thumbnail element identifier, and canceling the display of the other element display identifiers among the plurality of element display identifiers on the graphical user interface, the implementation further comprises:
restoring, in response to a first touch operation for the graphical user interface and during a duration of the first touch operation, the display of the other element display identifiers among the plurality of element display identifiers on the graphical user interface; and
canceling, in response to detecting that the first touch operation is ended, the display of the other element display identifiers among the plurality of element display identifiers on the graphical user interface.

In an embodiment, after the replacing the battle-related interface element in the expanded form displayed on the graphical user interface with the thumbnail element identifier, and canceling the display of the other element display identifiers among the plurality of element display identifiers on the graphical user interface, the implementation further comprises:
displaying, in response to a second touch operation for the thumbnail element identifier, an information display window on the graphical user interface, wherein the information display window is used to display all current battle information associated with the thumbnail element identifier; and
canceling, in response to any position on the graphical user interface other than the information display window, the display of the information display window.

In an embodiment, after the replacing the battle-related interface element in the expanded form displayed on the graphical user interface with the thumbnail element identifier, and canceling the display of the other element display identifiers among the plurality of element display identifiers on the graphical user interface, the implementation further comprises:
canceling, in response to a third touch operation for the thumbnail element identifier, display of the thumbnail element identifier on the graphical user interface.

In an embodiment, after the replacing the battle-related interface element in the expanded form displayed on the graphical user interface with the thumbnail element identifier, and canceling the display of the other element display identifiers among the plurality of element display identifiers on the graphical user interface, the implementation further comprises:
canceling, in response to a touch operation for the graphical user interface, display of all thumbnail element identifiers on the graphical user interface on the graphical user interface.

In an embodiment, before the responding to the event that the first virtual character enters the battle state, the implementation further comprises:
determining whether a current location of the first virtual character belongs to a preset battle region; and
determining, in response to the first virtual character currently being located in the preset battle region, that the first virtual character enters the battle state, and responding to the event that the first virtual character enters the battle state.

In an embodiment, before the responding to the event that the first virtual character enters the battle state, the implementation further comprises:
determining whether the first virtual character and other virtual characters have a game event of attacking or being attacked; and
determining, in response to the first virtual character and the other virtual characters have a game event of attacking or being attacked, that the first virtual character is in battle, and responding to the event that the first virtual character enters the battle state.

In an embodiment, the graphical user interface further comprises a second virtual character in a same camp as the first virtual character in the virtual scenario; and
before the responding to the event that the first virtual character enters the battle state, the implementation further comprises:
determining, in response to detecting that the second virtual character enters the battle state, that the first virtual character is in battle, and responding to the event that the first virtual character enters the battle state.

The above embodiments may be referred to for specific implementations of the above operations, which will not be repeated here.

In some embodiments, as shown in FIG. 10, the computer device 300 further comprises: a touch screen 303, a radio frequency circuit 304, an audio circuit 305, an input unit 306, and a power supply 307. The processor 301 is electrically connected to the touch screen 303, the radio frequency circuit 304, the audio circuit 305, the input unit 306, and the power supply 307 respectively. Those skilled in the art can understand that the structure of the computer device shown in FIG. 10 does not constitute any limitation to the computer device, and may comprise more or fewer components than those shown in the figure, or may combine some components, or may have different component arrangements.

The touch screen 303 may be configured to display a graphical user interface and receive an operating instruction generated by a user acting on the graphical user interface. The touch screen 303 may comprise a display panel and a touch panel. The display panel may be configured to display information inputted by the user or information provided to the user, and various graphical user interfaces of the computer device. These graphical user interfaces may be composed of graphics, texts, icons, videos, and any combination thereof. In some embodiments, the display panel may be configured in the form of, e.g., a liquid Crystal Display (LCD) or an Organic Light-Emitting Diode (OLED). The touch panel may be configured to collect a touch operation of the user thereon or in the vicinity thereof (such as an operation of the user on or in the vicinity of the touch panel using a finger, a touchpen, or any appropriate object or accessory), and generate a corresponding operating instruction, and the operating instruction executes a corresponding program. In some embodiments, the touch panel may comprise two parts: a touch detection apparatus and a touch controller. The touch detection apparatus detects a touch orientation of the user, detects a signal brought by the touch operation, and transmits the signal to the touch controller. The touch controller receives touch information from the touch detection apparatus, converts it into contact point coordinates, then transmits the contact point coordinates to the processor 301, can receive a command transmitted from the processor 301, and can execute the command. The touch panel can cover the display panel. After detecting the touch operation on or in the vicinity of the touch panel, the touch panel transmits the touch operation to the processor 301 to determine a type of a touch event, and then the processor 301 provides a corresponding visual output on the display panel based on the type of the touch event. In an embodiment of the present disclosure, the touch panel and the display panel may be integrated into the touch screen 303 to implement input and output functions. However, in some embodiments, the touch panel and the touch panel may be used as two standalone components to implement the input and output functions. That is, the touch screen 303 may also be used as a part of the input unit 306 to implement the input function.

In an embodiment of the present disclosure, the processor 301 executes a game application program to generate the graphical user interface on the touch screen 303. The touch screen 303 is configured to present a graphical user interface and receive an operating instruction generated by a user acting on the graphical user interface.

The radio frequency circuit 304 may be configured to transmit/receive a radio frequency signal, so as to establish wireless communication with a network device or other computer devices through wireless communication, and transmit/receive signals to/from the network device or other computer devices.

The audio circuit 305 may be configured to provide an audio interface between the user and the computer device through a speaker or a microphone. The audio circuit 305 can transmit an electrical signal converted from received audio data to the speaker, which converts the electrical signal into an acoustical signal and outputs the acoustical signal. On the other hand, the microphone converts the collected acoustical signal into an electrical signal, which is received by the audio circuit 305, and then converted into audio data. Then, the audio data is outputted to the processor 301 for processing, and then transmitted to, for example, another computer device through the radio frequency circuit 304, or the audio data is outputted to the memory 302 for further processing. The audio circuitry 305 may further comprise an earphone jack, to provide communication between a peripheral earphone and the computer device.

The input unit 306 may be configured to receive an inputted number, character information, or user feature information (such as a fingerprint, an iris, or facial information), and generate keyboard, mouse, joystick, optical or trackball signal input related to user settings and function control.

The power supply 307 is configured to power various components of the computer device 300. In some embodiments, the power supply 307 may be logically connected to the processor 301 through a power management system, thereby managing functions such as charging, discharging, and power consumption management through the power management system. The power supply 307 may further comprise one or more than one DC or AC power supply, a recharging system, a power failure detection circuit, a power converter or inverter, a power status indicator, and any other components.

Although not shown in FIG. 10, the computer device 300 may further comprise, e.g., a camera, a sensor, a wireless fidelity module, and a Bluetooth module, which will not be repeated here.

In the above embodiments, particular emphasis is laid on description of each embodiment. Relevant descriptions of other embodiments may be referred to for parts that are not described in detail in an embodiment.

As can be seen from the above, the computer device provided in this embodiment, by responding to an event that the first virtual character enters a battle state, replaces a battle-related interface element in the thumbnail form displayed on the graphical user interface with the battle-related interface element in an expanded form; then responds to an event that the first virtual character is out of the battle state, and restores the battle-related interface element in the expanded form displayed on the graphical user interface to the battle-related interface element in the thumbnail form. In the embodiments of the present disclosure, battle-related interface elements corresponding to different game states are selectively displayed on the graphical user interface based on a game state of the first virtual character controlled by a player, which can provide different interface display information in a targeted manner, and display secondary battle information in a thumbnail manner to display it differently from important battle information, thereby improving game interaction efficiency of the player, enhancing the sense of immersion, and improving the game experience of the player.

Those of ordinary skills in the art can understand that all or a part of the steps in the methods of the above embodiments can be completed through instructions, or be completed by controlling related hardware through instructions, wherein the instructions may be stored in a computer-readable storage medium, and loaded and executed by a processor.

To this end, an embodiment of the present disclosure provides a computer-readable storage medium in which a plurality of computer programs are stored. The computer programs can be loaded by a processor to implement steps in any one method for displaying a game element provided in embodiments of the present disclosure. For example, the computer programs can implement the following steps:
responding to an event that the first virtual character enters a battle state, and replacing the battle-related interface element in the thumbnail form displayed on the graphical user interface with a battle-related interface element in an expanded form; and
responding to an event that the first virtual character is out of the battle state, and restoring the battle-related interface element in the expanded form displayed on the graphical user interface to the battle-related interface element in the thumbnail form.

In an embodiment, the battle-related interface element in the expanded form comprises a plurality of element display identifiers; and
the responding to the event that the first virtual character is out of the battle state, and restoring the battle-related interface element in the expanded form displayed on the graphical user interface to the battle-related interface element in the thumbnail form comprises:
responding to the event that the first virtual character is out of the battle state, determining a target element display identifier from the plurality of element display identifiers, generating a thumbnail element identifier based on the target element display identifier and current battle information associated with the target element display identifier, and using the thumbnail element identifier as the battle-related interface element in the thumbnail form; and
replacing the battle-related interface element in the expanded form displayed on the graphical user interface with the thumbnail element identifier, and canceling display of other element display identifiers among the plurality of element display identifiers on the graphical user interface.

In an embodiment, the plurality of element display identifiers comprise a shortcut key identifier, an element graphic identifier, and a text identifier, wherein the shortcut key identifier is used for notifying a player to control the first virtual character to trigger the battle-related interface element associated with the shortcut key identifier in the virtual scenario;
the responding to the event that the first virtual character is out of the battle state, determining the target element display identifier from the plurality of element display identifiers, generating the thumbnail element identifier based on the target element display identifier and the current battle information associated with the target element display identifier, and using the thumbnail element identifier as the battle-related interface element in the thumbnail form comprises:
responding to the event that the first virtual character is out of the battle state, determining the shortcut key identifier from the plurality of element display identifiers as the target element display identifier, generating a thumbnail shortcut identifier based on the shortcut key identifier and the current battle information associated with the battle-related interface element, and using the thumbnail shortcut identifier as the battle-related interface element in the thumbnail form; and
the replacing the battle-related interface element in the expanded form displayed on the graphical user interface with the thumbnail element identifier, and canceling the display of the other element display identifiers among the plurality of element display identifiers on the graphical user interface comprises:
replacing the battle-related interface element in the expanded form displayed on the graphical user interface with the thumbnail shortcut identifier, and canceling display of the element graphic identifier and the text identifier on the graphical user interface.

In an embodiment, after the generating the thumbnail element identifier based on the target element display identifier and the current battle information associated with the target element display identifier, and before the using the thumbnail element identifier as the battle-related interface element in the thumbnail form, the implementation further comprises:
adjusting, in response to a size adjustment instruction for the thumbnail element identifier, a display size of the thumbnail element identifier to obtain an adjusted thumbnail element identifier, wherein a display size of the adjusted thumbnail element identifier is smaller than a display size of the element display identifier; and
using the adjusted thumbnail element identifier as the battle-related interface element in the thumbnail form.

In an embodiment, after the generating the thumbnail element identifier based on the target element display identifier and the current battle information associated with the target element display identifier, and before the using the thumbnail element identifier as the battle-related interface element in the thumbnail form, the implementation further comprises:
setting, in response to a color adjustment instruction for the thumbnail element identifier, a display color of the thumbnail element identifier to a specified display color to obtain a set thumbnail element identifier, wherein the display color of the set thumbnail element identifier is different from a display color of the element display identifier, so that the set thumbnail element identifier and the element display identifier are displayed differently; and
using the set thumbnail element identifier as the battle-related interface element in the thumbnail form.

In an embodiment, after the replacing the battle-related interface element in the expanded form displayed on the graphical user interface with the thumbnail element identifier, and canceling the display of the other element display identifiers among the plurality of element display identifiers on the graphical user interface, the implementation further comprises:
restoring, in response to a first touch operation for the graphical user interface and during a duration of the first touch operation, the display of the other element display identifiers among the plurality of element display identifiers on the graphical user interface; and
canceling, in response to detecting that the first touch operation is ended, the display of the other element display identifiers among the plurality of element display identifiers on the graphical user interface.

In an embodiment, after the replacing the battle-related interface element in the expanded form displayed on the graphical user interface with the thumbnail element identifier, and canceling the display of the other element display identifiers among the plurality of element display identifiers on the graphical user interface, the implementation further comprises:
displaying, in response to a second touch operation for the thumbnail element identifier, an information display window on the graphical user interface, wherein the information display window is used to display all current battle information associated with the thumbnail element identifier; and
canceling, in response to any position on the graphical user interface other than the information display window, the display of the information display window.

In an embodiment, after the replacing the battle-related interface element in the expanded form displayed on the graphical user interface with the thumbnail element identifier, and canceling the display of the other element display identifiers among the plurality of element display identifiers on the graphical user interface, the implementation further comprises:
canceling, in response to a third touch operation for the thumbnail element identifier, display of the thumbnail element identifier on the graphical user interface.

In an embodiment, after the replacing the battle-related interface element in the expanded form displayed on the graphical user interface with the thumbnail element identifier, and canceling the display of the other element display identifiers among the plurality of element display identifiers on the graphical user interface, the implementation further comprises:
canceling, in response to a touch operation for the graphical user interface, display of all thumbnail element identifiers on the graphical user interface on the graphical user interface.

In an embodiment, before the responding to the event that the first virtual character enters the battle state, the implementation further comprises:
determining whether a current location of the first virtual character belongs to a preset battle region; and
determining, in response to the first virtual character currently being located in the preset battle region, that the first virtual character enters the battle state, and responding to the event that the first virtual character enters the battle state.

In an embodiment, before the responding to the event that the first virtual character enters the battle state, the implementation further comprises:
determining whether the first virtual character and other virtual characters have a game event of attacking or being attacked; and
determining, in response to the first virtual character and the other virtual characters have a game event of attacking or being attacked, that the first virtual character is in battle, and responding to the event that the first virtual character enters the battle state.

In an embodiment, the graphical user interface further comprises a second virtual character in a same camp as the first virtual character in the virtual scenario; and
before the responding to the event that the first virtual character enters the battle state, the implementation further comprises:
determining, in response to detecting that the second virtual character enters the battle state, that the first virtual character is in battle, and responding to the event that the first virtual character enters the battle state.

The above embodiments may be referred to for specific implementations of the above operations, which will not be repeated here.

The storage medium may comprise, e.g., a Read Only Memory (ROM), a Read Access Memory (RAM), and a magnetic disk, or an optical disk.

The computer program stored in the storage medium, by responding to an event that the first virtual character enters a battle state, replaces a battle-related interface element in the thumbnail form displayed on the graphical user interface with the battle-related interface element in an expanded form; then responds to an event that the first virtual character is out of the battle state, and restores the battle-related interface element in the expanded form displayed on the graphical user interface to the battle-related interface element in the thumbnail form. In the embodiments of the present disclosure, battle-related interface elements corresponding to different game states are selectively displayed on the graphical user interface based on a game state of the first virtual character controlled by a player, which can provide different interface display information in a targeted manner, and display secondary battle information in a thumbnail manner to display it differently from important battle information, thereby improving game interaction efficiency of the player, enhancing the sense of immersion, and improving the game experience of the player.

In the above embodiments, particular emphasis is laid on description of each embodiment. Relevant descriptions of other embodiments may be referred to for parts that are not described in detail in an embodiment.

A method for displaying a game element, an apparatus for displaying a game element, a computer device, and a storage medium provided in the embodiments of the present disclosure are introduced in detail above. The principles and implementations of the present disclosure are set forth herein with reference to specific examples. The description of the above embodiments is only used to help understanding the technical solutions and core concepts of the present disclosure. Those with ordinary skills in the art should understand that: the technical solutions disclosed in the above embodiments may still be modified or a part of the technical features thereof may be replaced equivalently. These modifications or replacements are not intended to make the essence of corresponding technical solutions depart from the scope of the technical solutions of the embodiments of the present disclosure.

1. A method for displaying a game element, comprising:
providing a graphical user interface by a terminal, wherein the graphical user interface comprises a virtual scenario, a first virtual character located in the virtual scenario and controlled by the terminal, and a battle-related interface element, the battle-related interface element being configured to indicate battle-related battle information, the first virtual character being in an out-of-battle state, the battle-related interface element displayed on the graphical user interface being a battle-related interface element in a thumbnail form;
in response to determining that the first virtual character enters a battle state, and replacing the battle-related interface element in the thumbnail form displayed on the graphical user interface with a battle-related interface element in an expanded form; and
in response to determining that the first virtual character is out of the battle state, and restoring the battle-related interface element in the expanded form displayed on the graphical user interface to the battle-related interface element in the thumbnail form.

2. The method for displaying a game element according to claim 1, wherein:
the battle-related interface element in the expanded form comprises a plurality of element display identifiers; and
restoring the battle-related interface element in the expanded form displayed on the graphical user interface to the battle-related interface element in the thumbnail form comprises:
determining a target element display identifier from the plurality of element display identifiers;
generating a thumbnail element identifier based on the target element display identifier and current battle information associated with the target element display identifier;
using the thumbnail element identifier as the battle-related interface element in the thumbnail form;
replacing the battle-related interface element in the expanded form displayed on the graphical user interface with the thumbnail element identifier; and
canceling display of other element display identifiers among the plurality of element display identifiers on the graphical user interface.

3. The method for displaying a game element according to claim 2, wherein:
the plurality of element display identifiers comprise a shortcut key identifier, an element graphic identifier, and a text identifier, wherein the shortcut key identifier is used for notifying a player to control the first virtual character to trigger the battle-related interface element associated with the shortcut key identifier in the virtual scenario;
determining the target element display identifier from the plurality of element display identifiers, generating the thumbnail element identifier based on the target element display identifier and the current battle information associated with the target element display identifier, and using the thumbnail element identifier as the battle-related interface element in the thumbnail form comprises:
determining the shortcut key identifier from the plurality of element display identifiers as the target element display identifier;
generating a thumbnail shortcut identifier based on the shortcut key identifier and the current battle information associated with the battle-related interface element; and
using the thumbnail shortcut identifier as the battle-related interface element in the thumbnail form; and
canceling the display of the other element display identifiers among the plurality of element display identifiers on the graphical user interface comprises:
canceling display of the element graphic identifier and the text identifier on the graphical user interface.

4. The method for displaying a game element according to claim 2, wherein after generating the thumbnail element identifier and before using the thumbnail element identifier as the battle-related interface element in the thumbnail form, the method further comprises:
adjusting, in response to a size adjustment instruction for the thumbnail element identifier, a display size of the thumbnail element identifier to obtain an adjusted thumbnail element identifier, wherein a display size of the adjusted thumbnail element identifier is smaller than a display size of the target element display identifier; and
using the adjusted thumbnail element identifier as the battle-related interface element in the thumbnail form.

5. The method for displaying a game element according to claim 2, wherein after generating the thumbnail element identifier and before using the thumbnail element identifier as the battle-related interface element in the thumbnail form, the method further comprises:
setting, in response to a color adjustment instruction for the thumbnail element identifier, a display color of the thumbnail element identifier to a specified display color to obtain a set thumbnail element identifier, wherein the display color of the set thumbnail element identifier is different from a display color of the target element display identifier, so that the set thumbnail element identifier and the target element display identifier are displayed differently; and
using the set thumbnail element identifier as the battle-related interface element in the thumbnail form.

6. The method for displaying a game element according to claim 2, wherein after canceling the display of the other element display identifiers among the plurality of element display identifiers on the graphical user interface, the method further comprises:
restoring, in response to a first touch operation for the graphical user interface and during a duration of the first touch operation, the display of the other element display identifiers among the plurality of element display identifiers on the graphical user interface; and
canceling, in response to detecting that the first touch operation is ended, the display of the other element display identifiers among the plurality of element display identifiers on the graphical user interface.

7. The method for displaying a game element according to claim 2, wherein after canceling the display of the other element display identifiers among the plurality of element display identifiers on the graphical user interface, the method further comprises:
displaying, in response to a second touch operation for the thumbnail element identifier, an information display window on the graphical user interface, wherein the information display window is used to display all current battle information associated with the thumbnail element identifier; and
canceling, in response to any position on the graphical user interface other than the information display window, the display of the information display window.

8. The method for displaying a game element according to claim 2, wherein after canceling the display of the other element display identifiers among the plurality of element display identifiers on the graphical user interface, the method further comprises:
canceling, in response to a third touch operation for the thumbnail element identifier, display of the thumbnail element identifier on the graphical user interface.

9. The method for displaying a game element according to claim 2, wherein after canceling the display of the other element display identifiers among the plurality of element display identifiers on the graphical user interface, the method further comprises:
canceling, in response to a touch operation for the graphical user interface, display of all thumbnail element identifiers on the graphical user interface on the graphical user interface.

10. The method for displaying a game element according to claim 1, wherein before determining that the first virtual character enters the battle state, the method further comprises:
determining whether a current location of the first virtual character belongs to a preset battle region; and
determining, in response to the first virtual character currently being located in the preset battle region, that the first virtual character enters the battle stat.

11. The method for displaying a game element according to claim 1, wherein before to determining that the first virtual character enters the battle state, the method further comprises:
determining whether the first virtual character and other virtual characters have a game event of attacking or being attacked; and
determining, in response to the first virtual character and the other virtual characters have a game event of attacking or being attacked, that the first virtual character is in battle.

12. The method for displaying a game element according to claim 1, wherein:
the graphical user interface further comprises a second virtual character in a same camp as the first virtual character in the virtual scenario; and
before determining that the first virtual character enters the battle state, the method further comprises:
determining, in response to detecting that the second virtual character enters the battle state, that the first virtual character is in battle.

13. (canceled)

14. A computer device, comprising:
a processor; and
a memory storing a plurality of instructions that, when executed by the processor cause the computer device to perform an operation comprising:
providing a graphical user interface, wherein the graphical user interface comprises a virtual scenario, a first virtual character located in the virtual scenario and controlled by the computer device, and a battle-related interface element, the battle-related interface element being configured to indicate battle-related battle information, the first virtual character being in an out-of-battle state, the battle-related interface element displayed on the graphical user interface being a battle-related interface element in a thumbnail form;
in response to determining that the first virtual character enters a battle state, and replacing the battle-related interface element in the thumbnail form displayed on the graphical user interface with a battle-related interface element in an expanded form; and
in response to determining that the first virtual character is out of the battle state, and restoring the battle-related interface element in the expanded form displayed on the graphical user interface to the battle-related interface element in the thumbnail form.

15. A non-transitory computer-readable storage medium, wherein the computer-readable storage medium stores a plurality of instructions, wherein the instructions are adapted to being loaded by a processor to preform an operation comprising:
providing a graphical user interface by a terminal, wherein the graphical user interface comprises a virtual scenario, a first virtual character located in the virtual scenario and controlled by the terminal, and a battle-related interface element, the battle-related interface element being configured to indicate battle-related battle information, the first virtual character being in an out-of-battle state, the battle-related interface element displayed on the graphical user interface being a battle-related interface element in a thumbnail form;
in response to determining that the first virtual character enters a battle state, and replacing the battle-related interface element in the thumbnail form displayed on the graphical user interface with a battle-related interface element in an expanded form; and
in response to determining that the first virtual character is out of the battle state, and restoring the battle-related interface element in the expanded form displayed on the graphical user interface to the battle-related interface element in the thumbnail form.

16. The computer device of claim 14, wherein:
the battle-related interface element in the expanded form comprises a plurality of element display identifiers; and
restoring the battle-related interface element in the expanded form displayed on the graphical user interface to the battle-related interface element in the thumbnail form comprises:
determining a target element display identifier from the plurality of element display identifiers;
generating a thumbnail element identifier based on the target element display identifier and current battle information associated with the target element display identifier;
using the thumbnail element identifier as the battle-related interface element in the thumbnail form;
replacing the battle-related interface element in the expanded form displayed on the graphical user interface with the thumbnail element identifier; and
canceling display of other element display identifiers among the plurality of element display identifiers on the graphical user interface.

17. The computer device of claim 16, wherein:
the plurality of element display identifiers comprise a shortcut key identifier, an element graphic identifier, and a text identifier, wherein the shortcut key identifier is used for notifying a player to control the first virtual character to trigger the battle-related interface element associated with the shortcut key identifier in the virtual scenario;
determining the target element display identifier from the plurality of element display identifiers, generating the thumbnail element identifier based on the target element display identifier and the current battle information associated with the target element display identifier, and using the thumbnail element identifier as the battle-related interface element in the thumbnail form comprises:
determining the shortcut key identifier from the plurality of element display identifiers as the target element display identifier;
generating a thumbnail shortcut identifier based on the shortcut key identifier and the current battle information associated with the battle-related interface element; and
using the thumbnail shortcut identifier as the battle-related interface element in the thumbnail form; and
canceling the display of the other element display identifiers among the plurality of element display identifiers on the graphical user interface comprises:
canceling display of the element graphic identifier and the text identifier on the graphical user interface.

18. The computer device of claim 16, wherein after generating the thumbnail element identifier and before using the thumbnail element identifier as the battle-related interface element in the thumbnail form, the operation further comprises:
adjusting, in response to a size adjustment instruction for the thumbnail element identifier, a display size of the thumbnail element identifier to obtain an adjusted thumbnail element identifier, wherein a display size of the adjusted thumbnail element identifier is smaller than a display size of the target element display identifier; and
using the adjusted thumbnail element identifier as the battle-related interface element in the thumbnail form.

19. The non-transitory computer-readable storage medium of claim 15, wherein:
the battle-related interface element in the expanded form comprises a plurality of element display identifiers; and
restoring the battle-related interface element in the expanded form displayed on the graphical user interface to the battle-related interface element in the thumbnail form comprises:
determining a target element display identifier from the plurality of element display identifiers;
generating a thumbnail element identifier based on the target element display identifier and current battle information associated with the target element display identifier;
using the thumbnail element identifier as the battle-related interface element in the thumbnail form;
replacing the battle-related interface element in the expanded form displayed on the graphical user interface with the thumbnail element identifier; and
canceling display of other element display identifiers among the plurality of element display identifiers on the graphical user interface.

20. The non-transitory computer-readable storage medium of claim 19, wherein:
the plurality of element display identifiers comprise a shortcut key identifier, an element graphic identifier, and a text identifier, wherein the shortcut key identifier is used for notifying a player to control the first virtual character to trigger the battle-related interface element associated with the shortcut key identifier in the virtual scenario;
determining the target element display identifier from the plurality of element display identifiers, generating the thumbnail element identifier based on the target element display identifier and the current battle information associated with the target element display identifier, and using the thumbnail element identifier as the battle-related interface element in the thumbnail form comprises:
determining the shortcut key identifier from the plurality of element display identifiers as the target element display identifier;
generating a thumbnail shortcut identifier based on the shortcut key identifier and the current battle information associated with the battle-related interface element; and
using the thumbnail shortcut identifier as the battle-related interface element in the thumbnail form; and
canceling the display of the other element display identifiers among the plurality of element display identifiers on the graphical user interface comprises:
canceling display of the element graphic identifier and the text identifier on the graphical user interface.

21. The non-transitory computer-readable storage medium of claim 19, wherein after generating the thumbnail element identifier and before using the thumbnail element identifier as the battle-related interface element in the thumbnail form, the operation further comprises:
adjusting, in response to a size adjustment instruction for the thumbnail element identifier, a display size of the thumbnail element identifier to obtain an adjusted thumbnail element identifier, wherein a display size of the adjusted thumbnail element identifier is smaller than a display size of the target element display identifier; and
using the adjusted thumbnail element identifier as the battle-related interface element in the thumbnail form.
